(19) United States
(12) Patent Application Publication
(10) Pub. No.: US 2016/0262429 A1
(43) Pub. Date: Sep. 15, 2016

(54) Method of Producing Dual-Textured Frozen Food Products and Products Made Therefrom

(71) Applicant: Frito-Lay North America, Inc., Plano, TX (US)

(72) Inventors: Robert Fase, JR., Frisco, TX (US); Sevugan Palaniappan, Plano, TX (US); Joshua S. Rivner, McKinney, TX (US)

(21) Appl. No.: 14/641,929

(22) Filed: Mar. 9, 2015

(51) Int. Cl. A23L 1/00; A23L 3/36

(52) U.S. Cl. CPC A23L 1/005; A23L 1/0107; A23L 3/363; A23V 2002/00

(57) ABSTRACT

A method for producing dual-textured frozen food products allows for the quick preparation of snack-sized frozen food products that maintain a crunchy exterior when heated for consumption within a microwave or an oven. The method uses increased total frying steps to fully fry the food product prior to freezing and packaging steps. By adding components such as alginate, calcium, carboxyl methyl cellulose, calcium dihydrogen diphosphate, and high amylose corn starch into the interior core, batter, and breading, and/or predust, moisture is better maintained within the interior. The resulting heated dual-textured food product has an exterior mimicking that of oil fried breaded food products despite its moist interior.

### TECHNICAL FIELD

The present invention generally relates to a method for the production of reheatable frozen foods. More specifically, the invention relates to dual-textured food products with crispy outer texture and a moist interior texture having fat-fried attributes when heated.

### BACKGROUND OF THE INVENTION

Current heated dual-textured frozen foods or breaded appetizers fail to deliver on texture. In particular, in the preparation of frozen foods having dual textures or fillings, the issue of moisture migration typically leads to an exterior soggy coating and a dry or gummy interior. For example, when heating frozen foods having a breaded exterior and a soft filling, the moisture from the interior of the product transfers out of the product and condenses on the exterior of the product. This is more of an issue when microwaving frozen foods due to the cool air in a microwave. However, this problem also persists when heating frozen foods in an oven, though to a somewhat lesser extent due to the hot air in an oven.

One currently used method of producing such reheatable frozen foods utilizes a par-flying step, to partially fry (without fully cooking) the dual-textured foods to an internal temperature of below 110° F., prior to freezing and packaging for delivery to consumers. The partially frying step provides the desirable fry flavor and effect within quick production times. However, this method relies on the use of commercial, rapid-cook convection and/or air impingement ovens to deliver texture. Such ovens are typically not as readily available to consumers compared to conventional and microwave and ovens. There remains a need for dual-textured frozen foods more comparable to a freshly fried product (i.e., one without intervening refrigerated or freezing steps), once heated or thawed in a microwave or conventional oven. There further remains a need for dual-textured frozen foods that are capable of maintaining a crisp, robust outer shell after heating. Such dual-textured frozen foods should be easily and quickly prepared as well as cost-efficient.

### SUMMARY OF THE INVENTION

Accordingly, presented herein is a method for the production of a dual-textured frozen food product that, when heated, comprises a texture similar to that of a product having been fried in oil, without intervening freezing steps. Generally, the frozen food product described herein contains an internal core or filling having a higher moisture content than its surrounding exterior. However, when heated for consumption, the frozen food products provide a crunchy exterior and a moist interior.

Generally, the method for preparing the dual-textured frozen food products comprises the steps of forming of an edible core material with an internal moisture content (i.e., edible core moisture) higher than that of the exterior, coating the edible core material with a batter and a breading to form a dual-textured food product, frying the dual-textured food product to form a fully cooked dual-textured food product and freezing the fully cooked food product. The food product may be fried to an internal temperature greater than about 140° F. to form the fully cooked dual-textured food product. The frying step may be performed in one frying step of more than 45 seconds and oil temperatures at 380° F. or above, or in two or more frying steps, each followed by two or more freezing steps. In one embodiment, a first frying step is performed to partially fry the dual-textured food product in less than 44 seconds at a temperature of above about 390° F., followed by freezing, a second frying step of about 1.5-3 minutes at a temperature of about 350° F. to an internal temperature of about 165° F.

The edible core material may comprise a water activity of about 0.97 in some embodiments. In embodiments, comprising glycerin, the edible core material may comprise a water activity (A_{w}) of between 0.85 to about 0.96. In one embodiment, the edible core material may comprise between about 2% to about 15% by weight glycerin. In one embodiment, the edible core material may comprise no more than 15% by weight glycerin. Battering and breading steps may be performed multiple times and may comprise the addition of at least about 40-50% core material and 50-60% breading or coating material. In one embodiment, battering and breading includes breading, batter and a predust, in steps occurring prior to frying. In one embodiment, the order is sequentially made as follows: predusting, battering, and then breading. However, the pre-dusting step and the battering step are generally interchangeable.

In some embodiments, one or more of the following are also added into the method: calcium-based substrate or solution into the breading of either at least a first predust pass or at least a first batter step, alginate into the batter of at least one battering step, carboxyl methyl cellulose into the batter of at least a first battering step, and an increased amount of about 1-5% toasted corn germ (by weight) on the overall product, and/or about calcium dihydrogen diphosphate into the batter of at least one battering step. In one embodiment, the dual-textured food product may further be coated with a high amylose corn starch prior to frying.

Other aspects, embodiments and features of the invention will become apparent in the following written detailed description and accompanying drawing.

### BRIEF DESCRIPTION OF THE DRAWINGS

The novel features believed characteristic of the invention are set forth in the appended claims. The invention itself, however, as well as mode of use and advantages thereof, will best be understood by reference to the following detailed description of illustrative embodiments when read in conjunction with the accompanying drawings, wherein:

FIG. 1 depicts a flowchart diagram of one embodiment of the method described herein.

FIG. 2 is a graphical representation depicting the water activity of one embodiment of the core of the food product described herein.

### DETAILED DESCRIPTION

As used herein, the term “dual-textured food product” refers to a food product containing at least two materials, defined as portions having different moisture contents, wherein one material is an edible core material and one material is an exterior material or coating. In one embodiment, the exterior material surrounds the core material on all or substantially all sides. In one embodiment, the core material comprises a moisture content higher than that of the exterior material. In one embodiment, the food products comprise a breaded exterior and a soft filling core material. In one embodiment, the core material is creamy. In one embodiment, the core material is cheese. In one embodiment, the breaded exterior is breaded (i.e., made using a batter and bread crumbs). In one embodiment, the fried product comprises about 6% moisture within the breaded exterior and less than about 15% moisture within the edible core, where the moisture content within the core material is higher than that of the exterior coating. The food products described herein may comprise any number of shapes or sizes including without limitation rectangles, squares, ovals, circles, triangles, or any number of polygons or characters. In one embodiment, the food product comprises about 40-50% core material. In one embodiment, the food product comprises about 50-60% exterior material. When heated for consumption, the food products described herein comprise a crunchy exterior and a moist interior. Unless otherwise specified, all percentages, parts and ratios as used herein refer to percentage, part, or ratio by weight of the total.

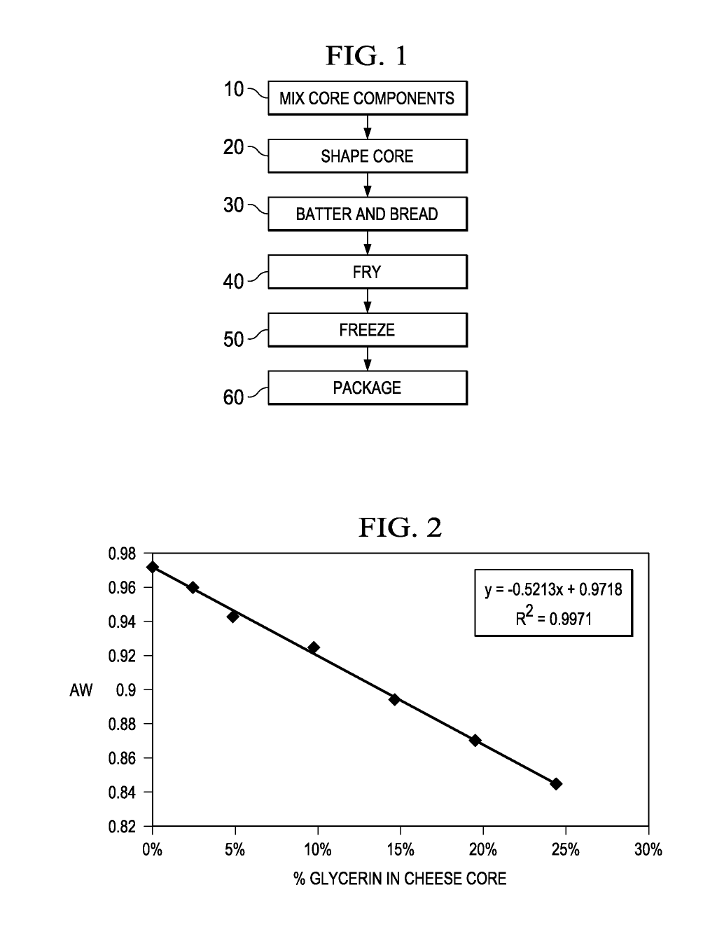

The method of creating the dual-textured food products described herein will now be described with reference to FIG. 1. In a first step, the core material is provided, which may include creating, forming, manufacturing, purchasing or otherwise obtaining the core material. As shown in FIG. 1, to form the core material, core components are gathered and mixed 10. Mixing may be performed by any means known in the art, including without limitation batch mixers such as a paddle or ribbon mixture. In one embodiment, mixing is performed between about 3 -6 minutes at about 30 -40 rpm.

In one embodiment, the core components comprise a cheese portion and water. The cheese portion may comprise any number of cheeses, and in any form, whether in powder or shredded form. In one embodiment, the core components comprise between about 70% to about 95% cheese portion and about 5-30% water. In one embodiment, the core components comprise between about 75% to about 86% cheese portion, with the remaining being water. In one embodiment, the core components comprise about 5-30% water. In one embodiment, the core components comprise less than 20% water. In one embodiment, the core components comprise between about 15% to about 20% water. In one embodiment, the core components comprise between about 15% to about 16% water. In one embodiment, the core components comprise less than about 16% water. In one embodiment, the core components comprise about 15.5% water. The core components may further optionally comprise about 0.5 -2.0% seasoning in one embodiment. In one embodiment, the core components comprise or consist of cheese, water and Carboxyl Methyl Cellulose (CMC) and optional seasonings. Suitable CMC is readily available from any number of manufacturers. In one embodiment, the core components comprise between about 0.5% and about 2% CMC. In one embodiment, the core components comprise about 0.5% CMC. Table 1 below provides a sample formulation of one embodiment of a core material described herein.

TABLE 1
Sample formulation for core material

| Component | % by weight |
|---|---|
| Shredded cheese | 79.5% |
| Cheese powder | 4% |
| Water | 15.5% |
| CMC | 0.5% .5-2 |
| Seasoning | 0.5% 0-5 |

In one embodiment, the core material comprising a cheese may further comprise glycerin to lower the moisture content of the core material. FIG. 2 illustrates the affect of binding water within the core material, found when testing glycerin amounts in a cheese core embodiment. Table 2 below indicates the values plotted in FIG. 2.

TABLE 2
Effect of glycerin on water activity (aw) in a cheese stick fried product

| % Glycerin in Cheese Core | a_{w} |
|---|---|
| 0% | 0.9718 |
| 2% | 0.9597 |
| 5% | 0.9426 |
| 10% | 0.9257 |
| 15% | 0.8941 |
| 20% | 0.87 |
| 24% | 0.8442 |

That range of glycerin would vary depending on water content of the cheese. In one embodiment, the core material comprises between about 2% and about 15% glycerin. In one embodiment, the core material comprises a water activity of about 0.85-0.96. Embodiments comprising glycerin may further comprise less than 1% flavor masker. Table 3 indicates a sample formula for a core material comprising glycerin.

TABLE 3
Cheese core formula containing glycerin

| Component | % by weight |
|---|---|
| Cheese | 84.5% |
| Glycerin | 15% |
| Flavor masker | 0.5% |

Returning to the discussion of the embodiment in FIG. 1, after mixing the components for the core material, the core material may be shaped 20 or compressed into any desired form. Generally, the core material may be fed into any forming equipment or mold by any means known in the art. By way of example, a spot depositor or patty former may be used to shape the core material into any desired shape.

Following shaping 20, the core material is subjected to batter and breading steps 30 to form an exterior around the core. Battering and breading steps 30 may be performed by any means known in the art, whether batch or continuous processes are used. In one embodiment, the core material undergoes multiple battering steps, each following by breading steps. Battering and breading steps are generally meant to refer to coating the core material 30. In one embodiment, the battering and breading steps 30 further comprise a predusting step to help adhere the batter and/or breading to the core material. In one embodiment, the predusting step may comprise application of a predust material to the core material. In one embodiment, the predust material may comprise one or more of the following: seasoning, flour (in any form), yellow corn meal, and soybean oil. This coating may include sequentially at least a first battering step, followed by a first breading step, followed by a second battering step; and then a second breading step. In one embodiment, the predusting step comprises coating the core with calcium. In one embodiment, the predusting step coats the core with about 1-5% by weight calcium. In this embodiment, the subsequent batter used to batter the core comprises alginate. Suitable calcium or alginate is readily available from any number of manufacturers. In embodiment, the batter comprises about 1-5% by weight alginate.

The battering step 30 generally comprises coating the core material with a batter. Thus, a coating step and the battering and breading step 30 may be used interchangeably. As used herein, a batter is defined as a liquid substance comprising water and flour. The battering step 30 comprises one or more battering passes, in which the core material is subjected to a coating of batter. In one embodiment, the batter comprises flour, seasoning, starch and optionally a protein such as whey. In one embodiment, the batter comprises a ratio of water to batter components of between about 1.5:1 to 2.5:1. In one embodiment, the batter comprises about 50%-75% water. In one embodiment, the batter components comprise flour (about 50-70%), seasoning (about 20-30%), cornstarch (about 15-20%), and hydrocolloids and whey powder (less than 1%). In one embodiment, at least a first battering step comprises coating the core material with a formulation containing carboxyl methyl cellulose (CMC). In one embodiment, the batter comprises between about 0.25% to about 2% CMC. In one embodiment, sufficient battering passes are performed to provide the overall product with between about 0.05 to about 1% CMC.

In one embodiment, at least a first battering step comprises coating the core material with a batter formulation containing calcium dihydrogen diphosphate. In one embodiment, the battering step 30 comprises use of a batter with between about 0.25-1.5% calcium dihydrogen diphosphate.

In some embodiments, at least one of the core material, the batter, the pre-dust, or the breading may comprise a complex dairy salt having a low percentage of little to no lactose. In one embodiment, the dairy salt may comprise about 70-80% mineral salts, about 10-20% protein, about 6-9% about 0.5-10% organic acids, with the remainder being water, wherein said mineral salts comprises one or more of calcium, magnesium, phosphorus, and sulfate. An example dairy salt includes a potassium-based composition with a potassium and sodium ratio of greater than about 2.0 and a masking fraction if necessary to conceal any off-flavor provided by the potassium. In one embodiment, the coating surrounding the core material comprises the complex dairy salt to be used in lieu of calcium dihydrogen diphosphate and in amounts of between about 0.25% to about 1.5% dairy salt.

In one embodiment, after battering and breading 30, the dual-textured or coated food product undergoes a further coating step, wherein it is coated with a solution of high amylose corn starch. In one embodiment, the dual-textured food product is coated with about 0.1-0.5% high amylose corn starch. In one embodiment, the dual-textured food product is coated with less than 1% high amylose corn starch.

Following battering and breading 30, the dual-textured food product then undergoes frying 40. Generally, the frying step comprises frying the dual-textured food product to an internal temperature greater than about 140° F. in a total of more than 45 seconds to form a fully cooked dual-textured food product. In one embodiment, the frying step comprises frying the dual-textured food product to an internal temperature of about 140° F-195° F. In one embodiment, one or more frying steps comprise frying at oil temperatures of above temperatures of 390° F. The frying step may be performed in one embodiment in a single frying step of more than 45 seconds and oil temperatures at 380° F. Suitable oils for frying include without limitation, and solely by way of example, soy, corn, canola, sunflower.

In one embodiment, the method for forming the frozen dual-textured food product comprises two frying steps 40 after battering and breading 30, each followed by one of two freezing steps, wherein the product is frozen after each frying step. In one embodiment, the method comprises partially frying the dual-textured food product for less than about 44 seconds at temperatures above about 390° F.; and freezing the partially fried dual-textured food product, wherein the frying step comprises a second frying step performed for between about 1.5 to about 3 minutes at a temperature of about 350° F. to the internal temperature, then frying the dual-textur ed food product to an internal temperature greater than 140° F. to form the fully cooked dual-textured food product which is then frozen again, thereby creating a twice fried, twice frozen food product. In one embodiment, the method comprises partially frying the dual-textured food product for less than 44 seconds at a temperature of between about 390 to about 393° F. In one embodiment, the method comprises a second frying step performed at between 350-450° F.

After frying 40, having fully fried the dual-textured food products, the food products next undergo freezing steps, wherein the food products are frozen at a temperature of less than about 10° F. In one embodiment, the freezing steps take place in a spiral freezer. However, many other types of freezers are also suitable. The frozen dual-textured frozen products may then undergo packaging 60 for shipping and/or sales to consumers. As described above, one advantage created by the frozen dual-textured food products described herein is the quick and easy heating in a microwave or conventional oven, with a resulting crunchy exterior texture. Another advantage is the maintaining of the crunch or crisp exterior after heating for a prolonged period of time, or the long shelf life of the crunchy treat. Another advantage created by the frozen dual-textured food product is the extended shelf-life of the product, in terms of both frozen shelf life, as well as heating survival (persistence of the texture after heating) after preparation or reconstitution, whether or not using a heat lamp or warming device. The shell around the cheese core protects moisture after preparation.

The invention illustratively disclosed herein suitably may be practiced in the absence of any element or limitation not specifically disclosed herein. The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims.

We claim:

1. A method for preparing dual-textured frozen food products having an edible core therein, said core comprising a moisture content greater than that of an exterior portion of the food products, said method comprising the steps of:
providing the edible core material;
coating the edible core material with a batter and a breading to form a dual-textured food product with an edible core material and a coating;
frying the dual-textured food product for a total time greater than about 45 seconds to an internal temperature greater than about 140° F. to form a fully cooked dual-textured food product; and
freezing the fully cooked dual-textured food product at temperatures less than about 10° F.

2. The method of claim 1 wherein the frying step comprises frying the dual-textured food product to an internal temperature of about 165° F.

3. The method of claim 1 further comprising, prior to the frying step, the steps of:
partially frying the dual-textured food product for less than about 44 seconds at temperatures of above about 390° F.; and
freezing the partially fried dual-textured food product,
wherein the frying step is performed for between about 2-3 minutes at a temperature of about 350° F. to the internal temperature, and
wherein the method creates a twice fried, twice frozen food product.

4. The method of claim 1 wherein the coating step comprises at least a first battering step, a first breading step, a second battering step; and a second breading step.

5. The method of claim 1 where the coating step comprises a predusting step comprising a predust with calcium, and wherein said batter comprises alginate.

6. The method of claim 1 wherein the batter comprises Carboxyl Methyl Cellulose.

7. The method of claim 1 wherein the edible core material comprises a water activity of between about 0.85 and about 0.96.

8. The method of claim 1 wherein the edible core material comprises glycerin.

9. The method of claim 8 wherein the edible core comprises no more than about 15% by weight glycerin.

10. The method of claim 1 comprising the step of applying a high amylose corn starch to the coating prior to frying.

11. The method of claim 1 wherein the batter comprises calcium dihydrogen diphosphate.

12. The method of claim 1 wherein, after the frying step, the edible core comprises a moisture content higher than that of the exterior.

13. The method of claim 1 comprising incorporation of a dairy salt into at least one of the edible core or the coating, said dairy salt having about 70-80% mineral salts, 10-20% protein, 6-9% organic acids, 0.5-10% lactose, with the remainder portion consisting of water, and wherein said mineral salts comprises one or more of calcium, magnesium, phosphorus, and sulfate.

14. A frozen dual-textured food product capable of maintain a crunchy exterior when thawed for consumption, said frozen dual-textured food product comprising about 40-50% of an edible core edible core and about 50-60% of a breaded exterior, the core comprising at least about 70% cheese and between about 0.5% and about 2% carboxyl methyl cellulose.

15. The frozen dual-textured food product of claim 14 comprising about 6% moisture within the breaded exterior and less than about 15% moisture within the edible core, wherein said moisture within the edible core is higher than the moisture within the breaded exterior.

16. The frozen dual-textured food product of claim 14 comprising between about 0.25-1.5% calcium dihydrogen diphosphate within the breaded exterior.

17. The frozen dual-textured food product of claim 14 comprising between about 0.25-1.5% dairy salt within the breaded exterior.
